(19) United States
(12) Patent Application Publication
(10) Pub. No.: US 2026/0133843 A1
(43) Pub. Date: May 14, 2026

(54) SYSTEMS AND METHODS FOR SERVICE LEVEL AGREEMENTS FOR FOUNDATION MODEL APPLICATIONS

(71) Applicant: Huawei Technologies Co., Ltd., Shenzhen (CN)

(72) Inventors: Kishanthan Thangarajah, Scarborough (CA); Arthur Chun-Yin Leung, Kingston (CA); Haoxiang Zhang, Scarborough (CA); Boyuan Chen, Richmond Hill (CA); Ahmed E. Hassan, Kingston (CA)

(21) Appl. No.: 19/197,315

(22) Filed: May 2, 2025

Related U.S. Application Data
(60) Provisional application No. 63/719,412, filed on Nov. 12, 2024.

(51) Int. Cl. G06F 9/50; G06F 9/48

(52) U.S. Cl. CPC G06F 9/5044; G06F 9/4881; G06F 2209/503

(57) ABSTRACT

Systems and methods are described for scheduling and/or resource provisioning for foundation model applications. The scheduler may involve determining a slack from a performance characteristic and an amount of consumed resources for a workflow request; determining an available resource for at least one replica; selecting a replica, from the at least one replica, associated with a maximum amount of the available resource; and routing at least one model to a task queue associated with the selected replica for execution. The resource provisioner may involve determining a remaining slack from an associated performance characteristic and an amount of consumed resources for a workflow request; determining a remaining resource to complete the workflow request; tracking a slack violation amount when the remaining resource exceeds the remaining slack; and increasing a number of replicas processing the workflow request based at least on the slack violation amount.

### CROSS-REFERENCE TO RELATED APPLICATIONS

This application claims the benefit of U.S. Provisional Application No. 63/719,412, filed on Nov. 12, 2024, which application is hereby incorporated herein by reference.

### TECHNICAL FIELD

The description herein relates generally to foundation model applications. More particularly, the description relates to systems and methods for scheduling and/or resource provisioning for foundation model applications.

### BACKGROUND

Several techniques have been previously applied to scheduling and/or resource provisioning. For example, Ray Serve's scheduling is based on PowerOfTwoChoices where a random two replicas are chosen and then out of the two, one with the shortest queue length is selected. Ray Serve's autoscaling feature automatically increases or decreases a deployment's number of replicas based on the queue length.

In another example, Mélange solves Graphics Processing Unit (GPU) allocation minimal-cost optimization in navigating among request sizes, request rates, latency Service Level Agreements (SLAs). The system allocates accelerator resources according to a distribution of incoming requests.

In yet another example, HorizontalPodAutoscaler is implemented as an Application Programming Interface (API) resource and a controller. The resource determines the behavior of the controller. All resources required to run one instance of the application are abstracted into a pod, as such the system scales more pods to serve more instances of the application. It can monitor hardware metrics such as CPU and memory utilization, and the horizontal pod autoscaling controller can use these metrics as signals and perform autoscaling based on them.

In other examples, Fast Chat's scheduling feature is based RoundRobin where the central controller selects the worker on round robin manner. NVIDIA Triton has each model deployment with its own scheduler which combines batching the requests and then uses round robin-based strategy to select model instance. ServerlessLLM schedules a model instance by assessing model checkpoint locality with live migration of requests to leverage local checkpoint storage. Lluminix monitors load on each instance, the characteristics of the incoming requests, and the overall system performance and uses this data to select which instance to live migrate requests. Teola uses an optimized graph and then batches requests together which have the same topological depth and execute on a model instance.

### SUMMARY

Any and/or all aspects as described herein in any and/or all combinations are provided. The aspects herein may provide for autoscaling at a per-model level while incorporating service level agreement (SLA) awareness at the application workflow level. The techniques may reduce overprovisioning and/or under-provisioning of replicas of machine learning models dynamically during operation.

According to an aspect, there is provided a system having a processor configured to execute instructions from a computer-readable medium. The instructions may comprise: determining a slack from a performance target and an amount of consumed resources for a workflow request; determining an available resource for at least one replica; selecting a chosen replica, from the at least one replica, based on an amount of the available resource; and routing the at least one machine learning model to a task queue associated with the chosen replica for execution. In another aspect, the instructions may further comprise: setting a priority based on the slack.

According to another aspect, there is provided a system having a processor configured to execute instructions from a computer-readable medium. The instructions may comprise: determining a remaining slack from an associated performance target and an amount of consumed resources for a workflow request; determining a remaining resource to complete the workflow request; tracking a slack violation amount when the remaining resource exceeds the remaining slack; and increasing a number of replicas processing the workflow request based on the slack violation amount.

According to yet another aspect, there is provided a computer-implemented method that may comprise: determining a slack from a performance target and an amount of consumed resources for a workflow request; determining an available resource for at least one replica; selecting a replica, from the at least one replica, associated with a maximum amount of the available resource; and routing the at least one machine learning model to a task queue associated with the selected replica for execution. The method may further comprise: setting a priority based on the slack.

According to yet another aspect, there is provided a computer-implemented method that may comprise: determining a remaining slack from an associated performance target and an amount of consumed resources for a workflow request; determining a remaining resource to complete the workflow request; tracking a slack violation amount when the remaining resource exceeds the remaining slack; and increasing a number of replicas processing the workflow request based at least on the slack violation amount.

According to yet another aspect, there is provided a system having at least one processor; and a memory coupled to the at least one processor, the memory storing a plurality of processor-executable instructions. The instructions, when executed, configure the at least one processor to: determine a slack from a performance target and an amount of consumed resources for a workflow request, the workflow request referencing a workflow, the workflow comprising at least one machine learning model; determine an available resource for at least one replica executing on at least one computational node; select a chosen replica, from the at least one replica, based on an amount of the available resource; and route the at least one machine learning model to a task queue associated with the chosen replica for execution.

The instructions may further configure the at least one processor to: resolve the workflow into the at least one machine learning model and determine an execution sequence for the at least one machine learning model; and route the at least one machine learning model in the execution sequence into a request queue. The instructions may further configure the at least one processor to: retrieve, from the request queue, a retrieved model from the at least one machine learning model; identify the workflow request corresponding to the retrieved model to determine the slack from the performance target and the amount of the consumed resources; and/or select the retrieved model based on the slack corresponding to the amount of the available resource of the chosen replica.

The instructions may further configure the at least one processor to: determine a remaining resource to complete the workflow request; track a slack violation amount responsive to the remaining resource exceeds the slack; deploy at least one new replica to the at least one computational node; and/or route at least one remaining task node of the workflow referenced by the workflow request to the task queue associated with the at least one new replica. An amount of the at least one new replica may be based on the slack violation amount.

The instructions may further configure the at least one processor to: profile the workflow to determine a profiled slack with an offline profiler; compare the slack to the profiled slack; and/or responsive to the slack exceeding the profiled slack, deploy at least one new replica to the at least one computational node.

The instructions may further configure the at least one processor to: aggregate a plurality of metrics to determine the amount of the consumed resources when determining the slack; and/or weight at least one of the metrics as part of the aggregation.

According to yet another aspect, there is provided a computer-implemented method comprise: determining a slack from a performance target and an amount of consumed resources for a workflow request, the workflow request referencing a workflow, the workflow comprising at least one machine learning model; determining an available resource for at least one replica executing on at least one computational node; selecting a chosen replica, from the at least one replica, based on an amount of the available resource; and routing the at least one machine learning model to a task queue associated with the chosen replica for execution.

The computer-implemented method may further comprise: resolving the workflow into the at least one machine learning model and determine an execution sequence for the at least one machine learning model; routing the at least one machine learning model in the execution sequence into a request queue; retrieving, from the request queue, a retrieved model from the at least one machine learning model; identifying the workflow request corresponding to the retrieved model to determine the slack from the performance target and the amount of the consumed resources; and/or selecting the retrieved model based on the slack corresponding to the amount of the available resource of the chosen replica.

The computer-implemented method may further comprise: determining a remaining resource to complete the workflow request; tracking a slack violation amount responsive to the remaining resource exceeds the slack; deploying at least one new replica to the at least one computational node; and/or routing at least one remaining task node of the workflow referenced by the workflow request to the task queue associated with the at least one new replica. An amount of the at least one new replica may be based on the slack violation amount.

The computer-implemented method may further comprise: profiling the workflow to determine a profiled slack with an offline profiler; comparing the slack to the profiled slack; responsive to the slack exceeding the profiled slack, deploying at least one new replica to the at least one computational node.

The computer-implemented method may further comprise: aggregating a plurality of metrics to determine the amount of the consumed resources for determining the slack; and/or weighting at least one of the metrics as part of the aggregating.

According to an aspect, there is provided a device comprising a processor executing a plurality of instructions from a computer-readable memory, the instructions to configure the processor to perform any of the methods described herein.

According to an aspect, there is provided a computer-readable medium (or computer program product) storing computer-executable instructions that, when executed by one or more processors, cause the one or more processors to perform any of the methods described herein.

### BRIEF DESCRIPTION OF THE DRAWINGS

The aspects are described, by way of example, with reference to the attached Figures, wherein:

FIG. 1 is an overall block diagram of a computing structure incorporating a resource provisioner and a replica router;

FIG. 2 is a block diagram of a workflow request receiver;

FIG. 3 is a block diagram of a request router;

FIG. 4 is a block diagram of a control plane;

FIG. 5 is a block diagram of the replica router;

FIG. 6 is a block diagram of the resource provisioner;

FIG. 7 is a block diagram of Graphic Processing Unit cluster;

FIG. 8 is a block diagram demonstrating a cluster configured to execute instructions;

FIG. 9 is a block diagram of a cluster processor having one or more processors configured to execute instructions from one or more memories;

FIG. 10 is pseudocode for a Service Level Agreement aware scheduler;

FIG. 11 is pseudocode for a Service Level Agreement aware resource provisioner;

FIG. 12 is pseudocode for a Service Level Agreement aware resource provisioner computing a weighted exceeded ratio;

FIG. 13 is pseudocode for a Service Level Agreement aware resource provisioner computing a maximum exceeded ratio;

FIGS. 14 and 15 are examples demonstrating the SLA-aware scheduler in comparison to a power-of-two scheduler; and

FIGS. 16 and 17 are examples demonstrating the SLA-aware scheduler with prioritization in comparison to a power-of-two scheduler.

### DETAILED DESCRIPTION OF ILLUSTRATIVE EMBODIMENTS

One or more foundation models may be used to solve specific problems and/or provide services across diverse domains. These foundation models may be used in sequence or workflows, invoking a model one after the other or more complex patterns. Foundation models are a type of artificial intelligence (AI) model trained on datasets to perform a wide range of tasks. The foundation model may serve as a basis for creating more specialized applications. Foundation models may employ deep learning architectures, such as transformers, which may use multilayered neural networks to process and generate data. Foundation models may be trained using self-supervision on large, diverse datasets, so that the models may learn patterns, relationships, and/or context from the data.

The foundation models, or machine learning models, may be deployed on specialized accelerator hardware (e.g. graphics processing units and/or neural processing units) before the foundation model may be used by applications. For example, two physical machines may be provisioned with eight graphical processing units (GPUs) each for a total of 16 GPUs. Each of these applications may have customer requirements, known as a Service Level Agreement (SLA) or Service Level Agreements (SLAs). For example, a customer may specify an SLA of 40-seconds, meaning the application should finish within a latency of 40-seconds from a time of receiving a workflow request 204. Some such examples that may involve large language models (LLMs) (e.g. Llama, ChatGPT, LLaVA, ChatGLM), training and inference, artificial intelligence products, computer vision, network intrusion detection systems (IDS), radio frequency (RF) spectrum analysis, Radio Detection and Ranging (RADAR) spatial imaging, and other scientific and industrial applications. The computing structure 100 may receive workflow requests 204 such as services and applications executing, but not limited to, earth monitoring, remote sensing, passive sensing and positioning, navigation and tracking, autonomous delivery and mobility and the like.

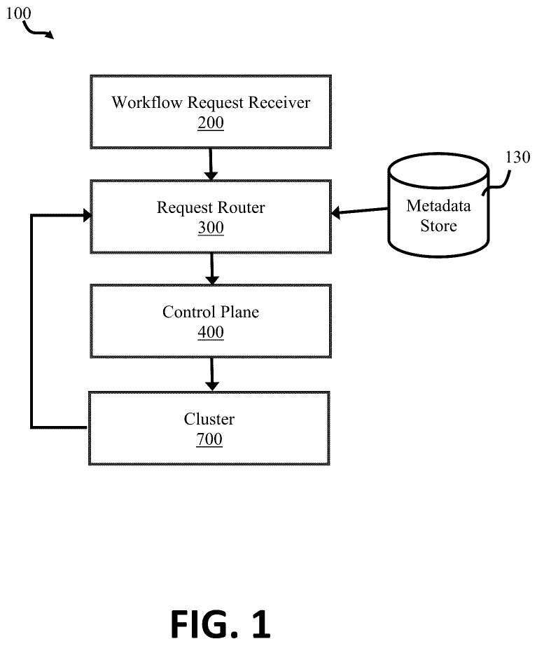

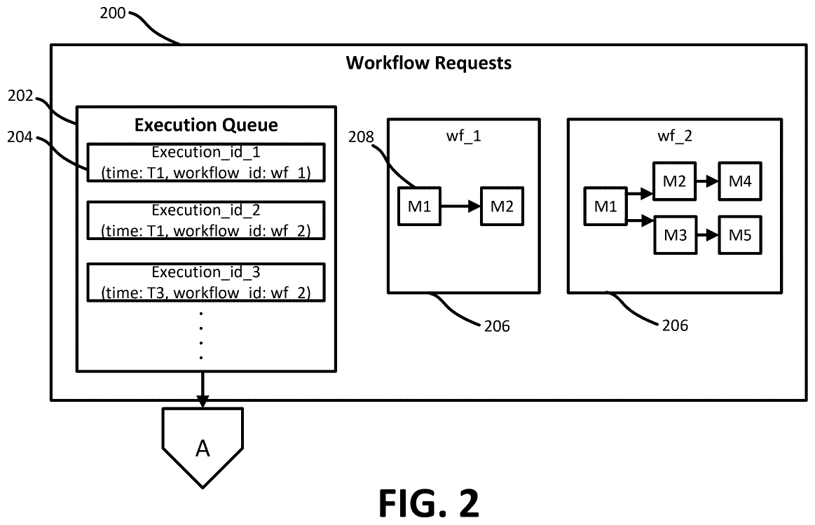

With reference to FIG. 1, a general process flow diagram for a computing structure 100, also known as a computing device or a computing system, may comprise one or more processes executing on one or more processors. The computing device may comprise means for executing one or more of the processes and/or methods as described herein. The processes may comprise a plurality of processor-executable instructions, when executed, cause the processor(s) to perform an intended task. In this aspect, the computing structure 100 may comprise a workflow request receiver 200, a workflow request router 300, a metadata store 130, a control plane 400, and/or a parallel processing cluster 700. Generally, the workflow request receiver 200 is configured to receive one or more workflow requests 204 from one or more external computing devices 860. The workflow requests 204 may be routed with the workflow request router 300 to one or more computational nodes 704 for execution. The workflow request router 300 may retrieve one or more parameters for the computational nodes 704 from the metadata store 130. The control plane 400 may make real-time decisions regarding the computational nodes 704 based on the operation of the parallel processing cluster 700, which performs the execution of the computational nodes 704. One or more metrics may be returned to the workflow request router 300 from the parallel processing cluster 700. Each of these processes is described in further detail herein. In FIGS. 2-4, and 7, process flow between the figures has been labelled with off-page connectors A-G.

Shown particularly in FIG. 2, the workflow request receiver 200 is configured to receive one or more workflow requests 204 from one or more external computing devices 860 over a network 850. The external computing devices 860 may comprise a user interface receiving input that may modify and/or control one or more processes described herein. The workflow request 204 may request a workflow 206 using a workflow identifier (e.g., wf_1, wf_2) and may provide data to be processed by the workflow 206. The workflow requests 204 may be assigned an execution identifier (e.g., Execution_id_1, Execution_id_2, etc.) and a time (e.g., T1, T3). The workflow request 204 may be added to an execution queue 202. In some aspects, the workflow request 204 may include a priority, execution constraints, etc. In some aspects, the workflow request 204 may include a service level agreement (SLA) specifying expected or target performance (e.g., performance target) in processing the workflow request 204.

The workflow 206 may comprise a task graph having one or more task nodes 208. One task node 208 is labelled to avoid obscuring the figure by labelling all the task nodes. The task graph defines the number of task nodes 208 and one or more edges between the task nodes 208. For example, workflow wf_1 comprises two task nodes 208 in a serial workflow. In another example, workflow wf_2 comprises five task nodes 208, with an initial task node M1 being executed and then task nodes M2, M4 executing serially in parallel with task nodes M3, M5 also executing serially. These workflows 206 are merely examples. More or fewer workflows 206 may be available to the workflow request receiver 200 and each workflow 204 may comprise more or fewer task nodes 208 in any arbitrary configuration. The workflows 206 may be specified by the one or more external computing devices 860 or retrieved from a workflow database (not shown). In this aspect, the workflow 206 may be provided by foundation model applications executing on the one or more external computing devices 860.

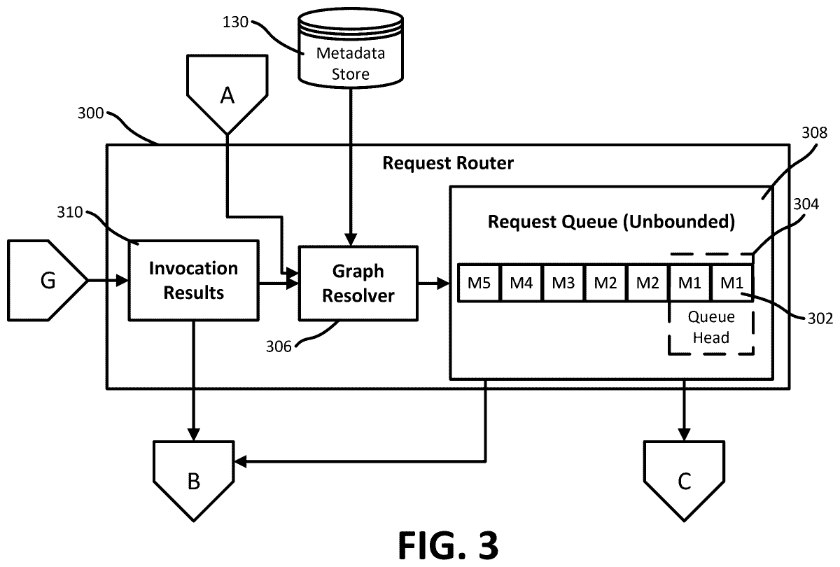

Turning to FIG. 3, the workflow request router 300 retrieves the workflow request 204 from the execution queue 202 of the workflow request receiver 200. The workflow request router 300 may retrieve the workflow 206 from the workflow request receiver 200 or from the metadata store 130. The workflow request 204 and the workflow 206 may be provided to a graph resolver 306. The graph resolver 306 may determine a dependency for the workflow 206 during runtime. The graph resolver 306 may determine an execution readiness of each task node 208. In this aspect, the graph resolver 306 may retrieve metadata on each of the workflow 206 from the metadata store 130. The metadata may include any measurable attribute of the workflow execution, such as inference latency, token generation speed, time between tokens, time to first token, total tokens generated, and/or inference cost incurred in generating tokens.

The graph resolver 306 may decompose task graphs of the workflow 206 by resolving the workflow 206 into the task nodes 208 and may determine an optimal order of execution (e.g., an execution sequence). The graph resolver 306 may analyze the structure of the task graph to determine the dependencies and constraints. The graph resolver 306 may comprise one or more algorithms to traverse the task graph to ensure that the task nodes 208 are executed in the specified sequence, respecting dependencies between the task nodes 208, and resource constraints. The graph resolver 306 may consider an availability of resources and the current state of each task. The graph resolver 306 may allocate resources, schedule tasks to avoid bottlenecks, and/or handle any dynamic changes in the workflows 206, such as task failures or new task additions. The graph resolver 306 may ensure that the workflows 206 are executed efficiently, optimizing for performance, and/or resource utilization. In some aspects, the graph resolver 306 may reorder the unbounded request queue 308 to ensure that the workflows 206 are executed efficiently, optimizing for performance, and/or resource utilization.

When the graph resolver 306 determines that a task node 208 is ready for execution, the execution-ready task node 302 may be placed at an end of an unbounded request queue 308 and assigned a model identifier corresponding to a machine learning model to process the execution-ready task node 302. The unbounded request queue 308 may grow dynamically as more execution-ready task nodes 302 are added. The unbounded request queue 308 may comprise one or more execution-ready task nodes 302. The execution-ready task node 302 may comprise one or more pointers to invocation results 310 to be processed by the execution-ready task node 302. The unbounded request queue 308 may comprise a queue head 304 and the replica router 500 executing in the control plane 400 may retrieve the execution-ready task node 302 from the queue head 304. When the graph resolver 306 determines that the task node 208 has no available data to process, the task node 208 may be placed in a wait state until such time that the graph resolver 306 receives invocation results 310 to process by the task node 208 that is in the wait state.

Although the unbounded request queue 308 may be unbounded, some techniques may limit the unbounded request queue 308. For example, a backpressure may control the flow of data by slowing down or pausing a production of new execution-ready task nodes 302, such as when memory may become exhausted. In another example, a dynamic resource allocation may allocate memory or other resources dynamically based on a size of the unbounded request queue 308. The dynamic resource allocation may involve swapping or storing execution-ready task nodes 302 to a long-term storage, such as a hard drive until resources become available. In yet another example, the graph resolver 306 may comprise instructions to limit a rate at which new task nodes 208 and/or workflows 206 may be prepared for the unbounded request queue 308.

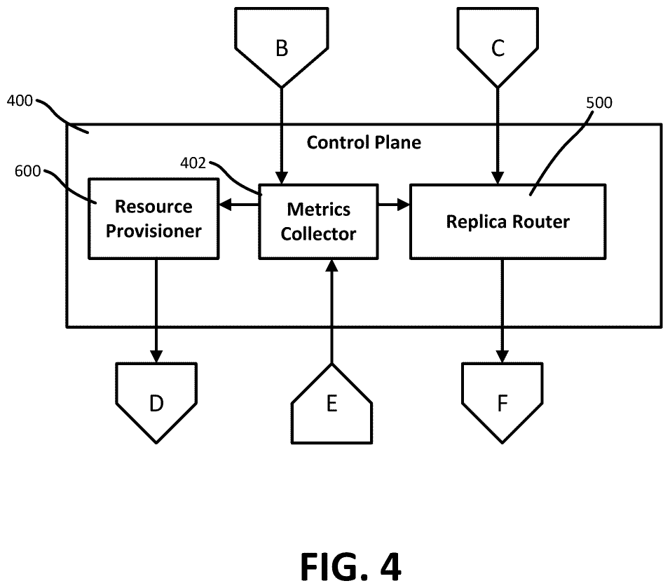

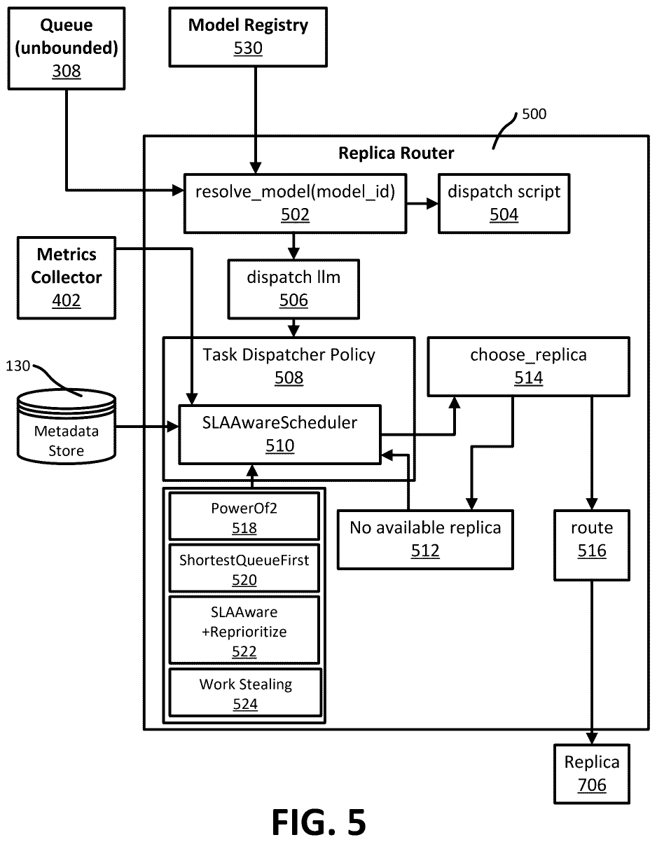

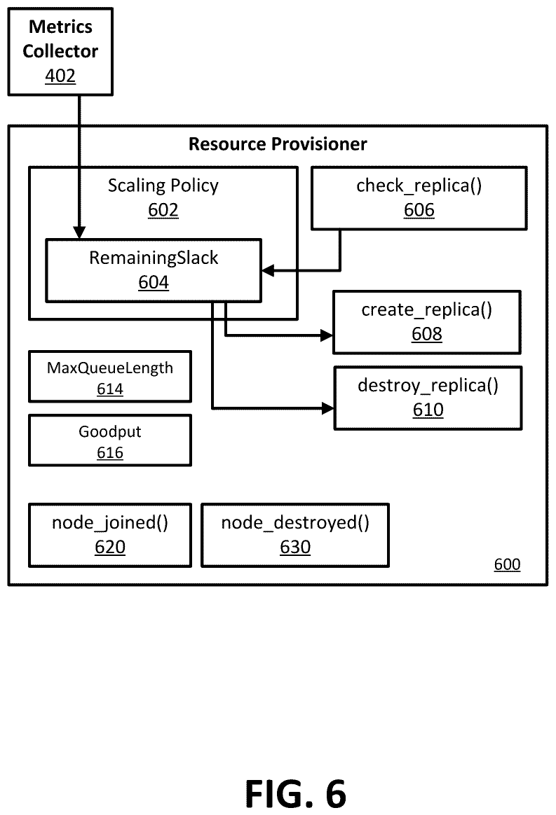

Turning to FIG. 4, the control plane 400 may make real-time decisions based on the operation of the parallel processing cluster 700. The control plane 400 may comprise a resource provisioner 600, a metrics collector 402, and a replica router 500. The metrics collector 402 may maintain global data from the workflow request router 300, the parallel processing cluster 700, and/or the computational nodes 704. The metrics collector 402 may provide the metrics to any process that requests the metrics for the purpose of optimizing performance. In this aspect, the metrics collector 402 may provide the metrics to the resource provisioner 600 and/or the replica router 500. The replica router 500 and the resource provisioner 600 are described in further detail below with reference to FIGS. 5 and 6 respectively. In this aspect, the metrics collector 402 may retrieve and/or determine one or more metrics from the invocation results 310 for the computational node 704 that produced the invocation results 310. The computational node metrics may comprise latency, average latency, percentile latency, throughput, error rate, success rate, resource use, memory use, response size, and/or disk input/output. The metrics collector 402 may retrieve and/or determine one or more metrics from the cluster orchestrator 702, such as monitoring resource usage, one or more performance metrics, concurrency, and/or health of the parallel processing cluster 700. The resource usage may comprise processor usage, memory usage, and/or disk input/output. The metrics collector 402 may collect and/or determine metrics from the unbounded request queue 308, such as queue length, pendency, etc.

Turning to FIG. 5, the replica router 500 may retrieve the execution-ready task node 302 from the unbounded request queue 308 for invocation from the queue head 304. Based on the model identifier of the execution-ready task node 302, a resolver process 502 may retrieve a machine learning model from a model registry 530. In some aspects, the resolver process 502 determines that the model is a script and a dispatch script process 504 may be executed. The script may generally involve executing a predefined set of instructions to perform specific tasks. For example, the script process may retrieve data, perform calculations, and/or execute system commands. When the resolver process 502 determines the model is an inference engine 710, such as an LLM, the resolver process 502 dispatches an inference engine process 506 by executing a balance function of a task dispatcher policy 508. The balance function may distribute tasks evenly across available resources. The balance function may retrieve one or more metrics from the metrics collector 402 to dynamically adjust allocation of tasks based on current load and resource availability.

In one aspect, the balance function may initiate a scheduler 510 to retrieve one or more metrics associated with one or more model replicas 706 from the metrics collector 402. The metrics from the metrics collector 402 may correspond to a type of the machine learning model specified by the execution-ready task node 302 retrieved from the unbounded request queue 308. The metrics may comprise data for the task queue 708 of each of the model replicas 706, performance data for each of the model replicas 706, and/or one or more runtime metrics from the metrics collector 402. The scheduler 510 may retrieve an expected inference latency from a profile corresponding to the model replicas 706 from the metadata store 130. Based on the metrics and the profile for the replicas 706, the scheduler 510 may select a particular replica 514 and a routing process 516 routes the model to the task queue 708 of the chosen replica 706. When no suitable replica 706 is available at step 512, the scheduler 510 retries to choose a replica 706 by continuing to retrieve updated metrics and/or updated profile data until a replica 706 meets predetermined criteria. In some aspects, when no available replicas 706 exist at step 512, the scheduler 510 may notify the resource provisioner 600 to create a new replica 706 (e.g., a newly executed replica) using the create replica process 608. The scheduler 510 may choose a chosen replica 706 based at least in part on a load balancing and/or compliance with a predetermined service level agreement (SLA). In this manner, the scheduler 510 may perform service level agreement scheduling at the workflow node level rather than using heuristics such as load, memory usage, or queuing length at global levels.

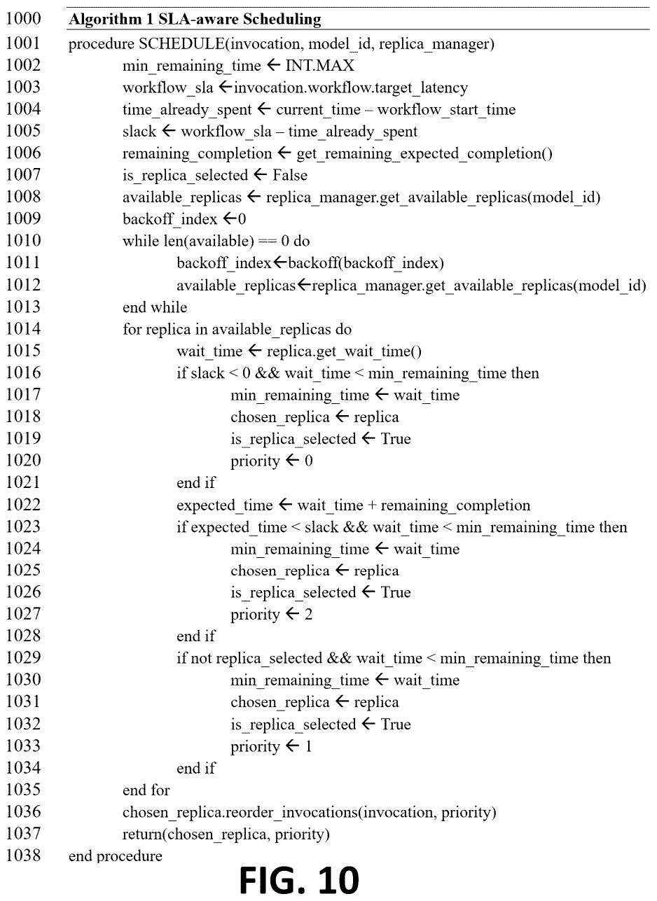

In some aspects, a scheduling method 1000 for the scheduler 510 may be selected from a power-of-two scheduler 518, a shortest queue first scheduler 520, a service level agreement scheduler with reprioritization 522, and/or a work-stealing scheduler 524. The selection of the scheduling method 1000 may be made by the workflow 206. The scheduling method 1000 for the service level agreement scheduler with reprioritization 522 is described in further detail with reference to FIG. 10 below.

The power-of-two scheduler 518 may organize tasks into a hierarchical structure based on powers-of-two, which may simplify the process of assigning and managing workloads. The power-of-two scheduler 518 may maintain a binary tree where each task node 208 represents a power-of-two, corresponding to a priority and/or a size of the task nodes 208. When a new task node 208 arrives, the power-of-two scheduler may determine an appropriate position in the hierarchy for the new task node 208 by comparing a workload and/or priority of the new task node 208 to the existing task nodes. The comparison may leverage a binary tree thereby enabling the power-of-two scheduler 518 to quickly locate the position for the new task node 208.

Once task nodes 208 are placed within the hierarchy, the power-of-two scheduler 518 may allocate resources by traversing the binary tree and assigning the task nodes 208 to available replicas 706. The traversal process ensures that task nodes 208 may be distributed evenly, preventing any single replica 706 from becoming overloaded. The power-of-two scheduler 518 may dynamically adjust to changes, such as fluctuations in workload and/or the addition of new task nodes 208. The binary tree structure may allow for rapid rebalancing and/or reassignment of the task nodes 208.

The shortest queue first scheduler 520 may optimize the allocation of task nodes 208 by prioritizing the task nodes 208 to the replicas 706 with the shortest task queue 708. The shortest queue first scheduler 520 may continuously monitor the length of each task queue 708. The shortest queue first scheduler 520 may minimize an overall waiting time and/or improve efficiency by ensuring that task nodes 208 are processed as quickly as possible. The shortest queue first scheduler 520 may select the replica 706 with the fewest number of task nodes 208 waiting to be executed. By doing so, the shortest queue first scheduler 520 may reduce bottlenecks and/or provide balanced distribution of workloads.

The work-stealing scheduler 524 may maximize resource utilization and minimize idle time by allowing idle replicas 706 (e.g., replicas not currently processing any tasks) to “steal” tasks from busier replicas 706. In a work-stealing scheduler 524, when the replica 706 completes the task nodes 208 in their respective task queue 708 and becomes idle, the replica 706 may attempt to steal task nodes 208 from the task queues 708 of other replicas 706. The work-stealing scheduler 524 may select a random or a specific victim replica 706 and may transfer one or more task nodes 208 from the task queue 708 of the victim replica 706. The work-stealing scheduler 524 may be effective in environments with irregular or unpredictable workloads.

Turning to FIG. 6, the resource provisioning may involve systematic distribution and management of one or more finite system resources (e.g. CPU, GPU, memory, etc.) among competing processes or applications to optimize performance, efficiency, and fairness in a computer system. The resource provisioner 600 may comprise a scaling policy 602, such as an autoscaling policy that dynamically adjusts a number of resources allocated in response to changes in demand. As described herein, the autoscaling process may consider SLA at the workflow 206 and/or may consider multi-tenant workflow requests 204 deployed simultaneously in a shared cluster while adhering to SLAs and/or service level objectives (SLO) for each tenant.

As described herein, slack may be used to determine resource provisioning. Generally, the slack refers to the unused capacity available to satisfy the target performance as specified by the SLA. Said another way, the slack is the available resources remaining for the workflow request 204 to complete while meeting the target performance. The available resources may be based on the target performance. For example, when the target performance specifies a complete time for the workflow request 204, then the available resources may be the amount of available time remaining to complete the workflow request 204. In another example, when the target performance specifies a processor usage target for the workflow request 204, then the available resources may be an amount of available processing slices to complete the workflow request 204.

To measure progress towards the target performance, the metrics collector 402 may track an amount of consumed resources for the workflow request 204. For example, the metrics collector 402 may determine an amount of time consumed from the start of the workflow 204 to a current time. In another example, the metrics collector 402 may determine an amount of computing time slices that have been consumed from the start of the workflow 204.

A slack may be a measure of a current performance to the target performance (i.e., an amount of remaining resources to complete the workflow 204). Generally, the slack may be determined for any number of performance targets and may correspond to unused or available resources. For example, a processor slack may be an amount of unused processing cycles available for use. In another example, a memory slack may be an amount of unused memory available for use. In yet another example, a network slack may be an amount of available bandwidth available for use. These examples of slack are not intended to be limiting. Any performance target may be measured to provide one or more performance metrics that may be used to evaluate slack for the parallel processing cluster 700. Examples of performance target may be GPU utilization, memory utilization, power consumption, temperature, error metrics, clock speeds, memory bandwidth utilization, duty cycle, etc. In this aspect, each of the computational nodes 704 may each have an associated slack.

A slack violation occurs in response to no more unused resources being available and the target performance is violated. For example, the SLA may specify a completion time for the workflow request 204 that the parallel processing cluster 700 fails to meet. The failure to meet the SLA results in a slack violation. The metrics calculator 402 may measure a slack violation amount (i.e., an amount corresponding to a count of the number of times a slack violation has occurred). The resource provisioner 600 may use the slack violation amount to deploy one or more new replicas to the computational nodes.

The techniques herein may reduce overprovisioning replicas 706 causing low utilization and may reduce under-provisioning replicas 706 causing high latency. In this aspect, the service level agreement corresponds with a target latency for the workflow request 204. Other aspects may have the service level agreement specify any measurable attribute such as a bandwidth, a cost, uptime availability, power usage, inference latency, token generation speed, time between tokens, time to first token, inference cost incurred in generating tokens, and/or any measurable quality/attribute of the system. Although the aspects herein refer to latency, the techniques described herein may apply equally well to any of the other service level agreements for use in the resource provisioner 600.

In an aspect, the resource provisioner 600 may comprise an offline profiler process that may estimate a workflow execution time and may allocate each computational node 704 with a profiled slack. The offline profiler process may perform statistical evaluations of the workflow during execution to determine the workflow execution time. These metrics may be stored in the metrics collector 402. During an online phase, an online slack for each workflow request 204 may be monitored by the resource provisioner 600. In general, the autoscaling may be executed when the online slack is exceeding or nearing (e.g., within a threshold of the profiled slack) the profiled slack, which may indicate imminent violations of the SLAs.

The scaling policy 602 may ensure optimal performance, cost-efficiency, and/or resource utilization. The scaling policy 602 may determine a remaining slack 604 by executing a check replica process 606 on a periodic basis. The remaining slack 604 may incorporate one or more metrics, such as a goodput metric 616 or a maximum queue length metric 614, from the metrics collector 402. The goodput metric 616 may represent an actual data rate processed by the replica 706. The maximum queue length metric 614 may measure a longest length of the unbounded request queue 308 over a specific period.

The check replica process 606 may receive current data from the metrics collector 402 regarding a state of the cluster 810. The check replica process 606 may perform several operations. For example, the check replica process 606 may ensure that replica 706 is operational, responsive, and/or not experiencing errors. In another example, the check replica process 606 may verify that the data in the replica 706 is consistent with a primary source or other replicas 706. In yet another example, the check replica process 606 may retrieve the status of the replica 706 from the metrics collector 402.

In some aspects, when the remaining slack 604 reaches zero or a negative amount, a create-replica process 608 may be executed to create more new replicas 706. In one aspect, the created replicas 706 may correspond to a number of expected slack violations (i.e., the slack violation amount). The create-replica process 608 may execute a number of functions. For example, the create-replica process 608 may copy data from a primary source or an existing replica 706 to the new replica 706. In another example, the create-replica process 608 may configure the new replica 706 based on one or more settings and/or parameters. In yet another example, the create-replica process 608 may allocate the resources for the new replica 706, such as CPU, memory, and storage. The create-replica process 608 may perform integration functions and/or verification functions. The new replicas 706 may be deployed to one of the computational nodes 704. In some aspects, one or more remaining execution-ready task nodes 302 of the workflow request 204 may be routed from the request queue 308 to the task queue 708 of the newly created replicas 706. In this manner, the remaining task nodes 302 for the workflow request 204 that may have slack violations are given priority processing by the newly created replicas 706 as the newly created replicas 706 may have a completely or nearly completely empty task queue 708.

When the remaining slack 604 exceeds a threshold, a destroy replica process 610 may be executed to reduce the replicas 706 and free up system resources. The threshold may be determined by the cluster orchestrator 702 and may depend on the size of the parallel processing structure 700 and/or the available resources exceed the remaining slack 604. In another aspect, the destroy replica process 610 may be executed according to an amount of time since the remaining slack 604 exceeds the threshold. The destroy replica process 610 may perform a shutdown of the replica 706, such as process termination, resource deallocation, and/or data cleanup. In some aspect, the destroy replica process 610 may update the cluster orchestrator 702, such as by updating routing tables, etc.

A node joined process 620 and/or a node destroyed process 630 may continuously update a system state and keep a consistent view of available resources. New resources may be marked as available when a new computational node joins the cluster 810 and/or existing resources may be marked as unavailable when a computational node drops out, such as in the case of network failures for example. The node joined process 620 may involve registering the new computational node 704, updating metadata, allocating resources, synchronizing the computational node 704, and/or notifying other computational nodes 704 of the new computational node 704.

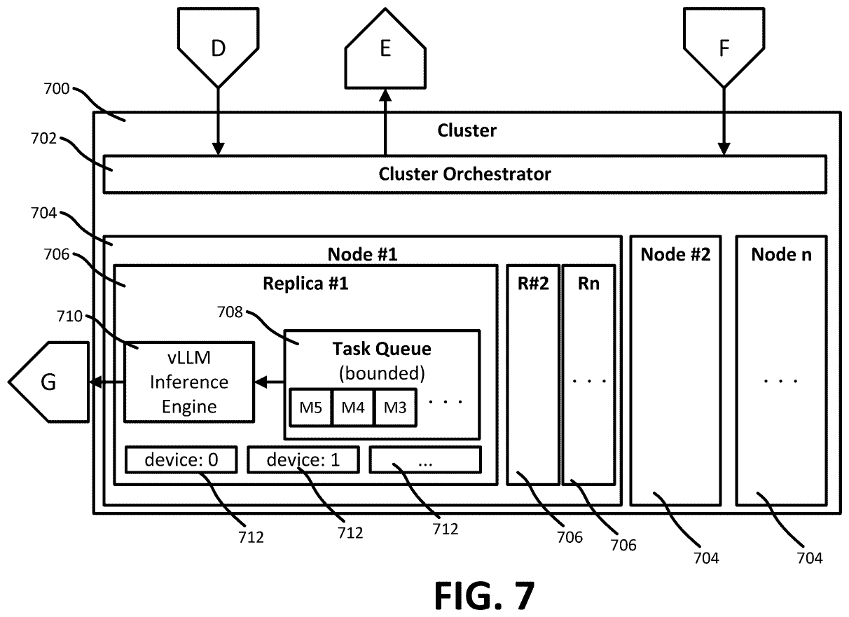

Turning to FIG. 7, the parallel processing cluster 700 may comprise a cluster orchestrator 702 that manages one or more hardware resources for executing the computational nodes 704. The cluster orchestrator 702 may use one or more orchestration tools such as Ray or Kubernetes for resource management and/or scalability. The cluster orchestrator 702 may act as a gateway between the control plane 400 and one or more execution or computational nodes 704 by receiving commands and/or overseeing an implementation of the computational nodes 704. The cluster orchestrator 702 may be responsible for managing and coordinating resources and workloads within the parallel processing cluster 700. The cluster orchestrator 702 may distribute computational resources (e.g., CPU, memory, storage), perform task scheduling, and perform scaling. In some aspects, the cluster orchestrator 702 may monitor a health of the parallel processing cluster 700. The cluster orchestrator 702 may manage registration and discovery of services of the parallel processing cluster 700 and/or perform configuration management. In one aspect, the cluster orchestrator 702 may execute on a cluster processor 810 as described in further detail below.

The computational nodes 704 may be a single unit within the parallel processing cluster 700 that performs specific computational tasks. The computational nodes 704 may be configured to process portions of a large dataset where the processed portions may be collated. Each of the computational nodes 704 within the parallel processing cluster 700 may host one or more model replicas 706, which is an instance of a model execution. A model replica 706 may represent an instance of model execution, such as a running copy of a machine learning model that performs computations. These model replicas 706 may be distributed across the computational nodes 704, with each computational node potentially hosting multiple replicas. The model replicas 706 may be assigned to each computational node 704.

The computational nodes 704 may each be equipped with one or more designated computing resources 712, such as a specified number of graphics processing units (GPUs) 814 and/or fractions of GPUs 814, as specified by the control plane 400. These resources are allocated and managed by the control plane 400, which ensures that each computational node 704 has the necessary computational power to execute the assigned model replicas efficiently.

Each model replica 706 may maintain a bounded local task queue 708, which is a data structure used to store tasks that need to be processed. The tasks in the bounded local task queue 708 may be managed to prevent queue overload.

Each model replica 706 may include an inference engine 710. This inference engine can be a large-language model (LLM), DeepSpeed, or another type of machine learning model. The inference engine 710 may retrieve tasks from the bounded local task queue 708 for processing. These tasks nodes 208 of the workflow 206 may be processed by one or more of the computational nodes 704.

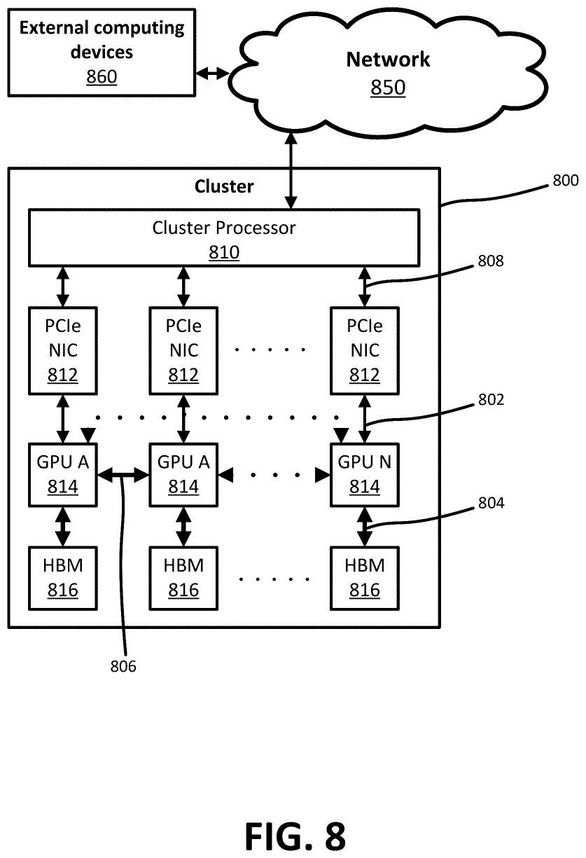

Turning to FIG. 8, a cluster 800 is shown. the external computing devices 860 may provide workflow requests 206 to a cluster processor 810 over a bi-directional computer network 850. The cluster processor 810 may be a single general purpose central processing unit (CPU), a multiple CPU, a multi-core CPU, or other type of processor for executing instructions from a memory (not shown). The processor 810 may execute all or portions of the computing structure 100 as described herein. For example, the processor 810 may execute the cluster orchestrator 702, the control plane 400, and/or the workflow request router 300.

The cluster processor 810 may interface with one or more Graphics Processing Units 814 (GPU) via one or more communication interfaces 812, such as network interface cards (NICs). The cluster processor 810 may communicate with the one or more communication interfaces via a network connection 808. Each of the NICs may be coupled to an associated graphics processing unit 814 via a bus 802. The bus 802 may comprise a bidirectional serial communication link. In this aspect, the bus 802 is a Peripheral Component Interconnect Express (PCIe) bus and comprises sixteen Generation 5 PCIe lanes from the NIC to the GPU 814 resulting in a theoretical serial link bandwidth of 504 Gbit/sec, excluding overhead. Each of the GPUs 814 may be coupled to a GPU memory 816 with a memory interface 804. In this aspect, the GPU memory 816 may be a GPU High Bandwidth Memory (HBM) and may have a theoretical bandwidth of 26,800 Gbit/sec. Each of the GPUs 814 may have a GPU-to-GPU communication network 806 comprising at least one GPU-to-GPU communication link and in this aspect, may have a theoretical GPU-to-GPU communication network bandwidth of 4,800 Gbit/sec.

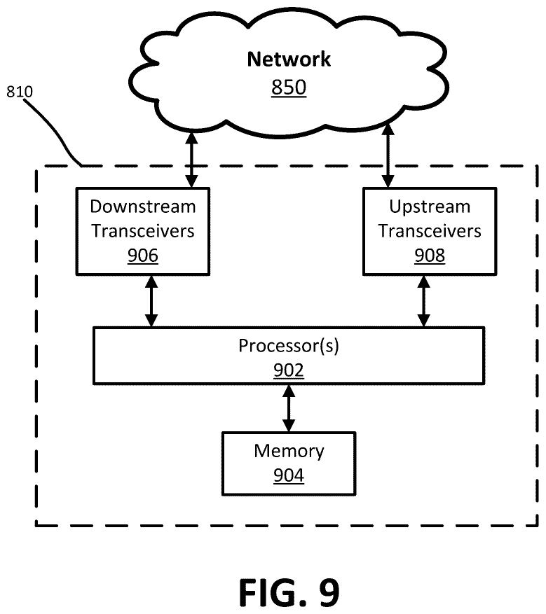

As shown in FIG. 9, the cluster processor 810 may comprise one or more processors 902 configured to execute instructions from one or more memories 904. The memory 904 is configured to store instructions used to perform operations described herein. The memory 904 may also be configured to store data that is used, generated, or collected by the cluster processor 810. For example, the memory 904 can store software instructions or modules configured to implement some or all the functionalities and/or operations described herein and that which are executed by the one or more processors 902.

The memory 904 is configured to store at least a part of the corresponding computer program instructions and/or data. In an example, the one or more processors 902 execute the computer program instructions stored in the memory 904 to implement related operations (for example, inputting, outputting, receiving, and transmitting) in the method embodiments disclosed herein. In some implementations, the memory 904 being configured to store the corresponding computer program instructions and/or data may mean that the memory 904 is configured to store all the corresponding computer program instructions and/or data for execution by the one or more processors 902. In some implementations, the memory 904 being configured to store the corresponding computer program instructions and/or data may mean that the memory 904 is configured to store a part of the corresponding computer program instructions and/or data. For example, the part of the corresponding computer program instructions and/or data may include computer program instructions and/or data that need to be currently executed by the one or more processors 902. Thus, the memory 904 may store different parts of computer program instructions and/or data for a plurality of times for the one or more processors 902 to perform related operations in the methods disclosed herein.

For clarity and to avoid overcrowding the illustration, only a single downstream transceiver 906, upstream transceiver 908, processor 902, and memory 904 are illustrated for simplicity, but the cluster processor 810 may include one or more other components.

The processor 902 may be coupled to one or more downstream transceivers 906 and/or one or more upstream transceivers 908. The downstream transceivers 906 and/or the upstream transceivers 908 may collectively be referred to as a communications module. In some aspects, the downstream transceivers 906 may be wired or wireless and likewise the upstream transceivers 908 may be wired or wireless. In the wireless aspects, the transceivers 906, 908 may be coupled to one or more antennas. For clarity, no antennas are illustrated. In some implementations, the transceivers 906, 908 may be separate transmitters and receivers. The transceivers 906, 908 are configured to modulate data or other content for transmission by one or more antennas, the communication interfaces 812, or the bus 802. The transceivers 906, 908 may also be configured to demodulate data or other content received by the one or more antennas, communication interfaces 812, and/or bus 802. A transceiver may include any suitable structure for generating signals for wireless or wired transmission and/or for processing signals received through wireless or wired communication. Each antenna includes any suitable structure for transmitting and/or receiving wireless or wired signals. The transceivers 906, 908 are configured to process signals and execute one or more communication protocols.

As a communication interface, the transceivers 906, 908 are configured to implement communication with another component. For example, the transceivers 906, 908 may communicate a signal with other apparatus/system such as a radio frequency processing apparatus, or processor system. The communication includes transmitting signals (or data, information) to another component or device, or receiving signals from another component or device. “Transmitting” includes outputting the signal to a component or device that is directly or indirectly coupled to the interface circuit (transmitting unit). “Receiving” includes inputting or obtaining a signal from a component or device that is directly or indirectly couped to the interface circuit (receiving unit). Optionally, to reduce a load of the one or more processors 902, a baseband signal processing circuit may be also disposed to implement processing of at least a part of baseband signals, including signal demodulation, modulation, encoding, decoding, or the like.

The processor 902 may be configured to perform operations (or methods) described herein as being performed by the cluster processor 810. Although not illustrated, in some implementations, the processor 902 may either be a part of the downstream transceivers 906 and/or a part of the upstream transceivers 908. Although not illustrated, in some implementations, the memory 904 may be a part of the processor 902.

The processor 902, along with the processing components of the downstream transceivers 906 and the upstream transceivers 908 may each be implemented by one or more processors 902 that may be the same or different. These processors 902 are configured to execute instructions stored in a memory (such as in the memory 904).

The processor 902 may be configured to perform other network side processing operations. In some implementations, the processor 902 may generate signaling data, to configure one or more parameters of the cluster processor 810 and/or one or more parameters of another cluster processor 810. Any signaling data generated by the processor 902 is sent by the downstream transceivers 906 and/or the upstream transceivers 908. The cluster processor 810 may further include a memory 904 that is configured to store instructions for performing the operations described herein. The memory 904 may also store data that is used, generated, or collected by the cluster processor 810. For example, the memory 904 can store software instructions or modules configured to implement some or all of the functionalities and/or implementations described herein and that which are executed by the processor 902.

The cluster processor 810 may be a communication device or an apparatus implemented in a communication device. For example, the cluster processor 810 may be an integrated circuit, which in some instances may be referred to as a chip, a modem, a modem chip, a baseband chip, or a baseband processor. In some implementations, one or more integrated circuits can be packaged into a system-on-chip, a system-in-package, or a multi-chip module. The cluster processor 810 can include one or more integrated circuits and other discrete components.

The computing structure 100 and/or the cluster processor 810 may include other components, not shown or described herein for the sake of clarity.

The GPU memory 816 is configured to store at least a part of the corresponding computer program instructions and/or data. In an example, the GPUs 814 execute the computer program instructions stored in the GPU memory 816 to implement related operations (for example, inputting, outputting, receiving, and transmitting) in the method embodiments disclosed herein. In some implementations, the GPU memory 816 being configured to store the corresponding computer program instructions and/or data may mean that the GPU memory 816 is configured to store the entire corresponding computer program instructions and/or data for execution by the one or more GPUs 814. In some implementations, the GPU memory 816 being configured to store the corresponding computer program instructions and/or data may mean that the GPU memory 816 is configured to store a part of the corresponding computer program instructions and/or data. For example, the part of the corresponding computer program instructions and/or data may include computer program instructions and/or data that need to be currently executed by the one or more GPUs 814. Thus, the GPU memory 816 may store different parts of computer program instructions and/or data for a plurality of times for the one or more GPUs 814 to perform related operations in the methods disclosed herein.

Turning to FIG. 10, a scheduling method 1000, when executed, may form the scheduler 510 according to an aspect. The scheduling method 1000 may retrieve the service level agreement for the workflow request 204 at step 1003. In this aspect, the service level agreement corresponds with a target latency for the workflow request 204. Other aspects may have the service level agreement specify a bandwidth, a cost, uptime availability, power usage, inference latency, token generation speed, time between tokens, time to first token, inference cost incurred in generating tokens, and/or any measurable quality/attribute of the system. Although the aspects herein refer to latency, the techniques described herein may apply equally well to any of the other service level agreements.

At step 1004, a processing time spent on the workflow request 204 may be determined based on the workflow start time and a current time. At step 1005, a slack may be determined as a difference between the service level agreement (e.g. target latency) and the processing time spent. In this aspect, the slack may be a buffer time available within a maximum allowed latency defined by the service level agreement. At step 1006, a remaining time for completion may be retrieved for the workflow request 204. A set of available replicas 706 may be retrieved based on the model identifier at step 1008. The available replicas 706 may be determined based on the type of the model. When no available replicas 706 are returned, the scheduling method 1000 waits at steps 1010 to 1013 until at least one available replica is retrieved and may incorporate a backoff process at step 1011.

For each replica retrieved from the set of available replicas, a wait time for the replica 706 may be determined at step 1015.

When the wait time is less than a minimum remaining time and the slack is less than or equal zero at step 1016, indicating that the service level agreement has been violated (i.e. a violation condition), the minimum remaining time may be replaced with the current wait time for the current replica at step 1017 and a chosen replica 706 may be selected to be the current replica at step 1018. A replica selected flag may be set to True at step 1019 and a priority is set to zero at step 1020 indicating the highest priority.

An expected time to completion may be calculated at step 1022 based on the wait time for the replica 706 and the remaining time for completion determined in step 1006 and may be based on one or more profiled values and/or past execution times for the same replicas 706 and/or similar replicas 706.

When the wait time is less than a minimum remaining time and the slack is less than the expected time to completion at step 1023, indicating that no violation may be expected, the minimum remaining time may be replaced with the current wait time for the current replica at step 1024 and a chosen replica 706 may be selected to be the current replica 706 at step 1025. A replica selected flag may be set to True at step 1026 and a priority is set to two at step 1027 indicating the lowest priority.

When the wait time is less than a minimum remaining time and no replica has been selected as indicated by the replica selected flag at step 1029, indicating that a violation is expected, the minimum remaining time may be replaced with the current wait time for the current replica at step 1030 and a chosen replica 706 may be selected to be the current replica at step 1031. A replica selected flag may be set to True at step 1032 and a priority is set to one at step 1033 indicating the moderate priority.

Although the example provided describes three priority levels, other aspects may have more or fewer priority levels. For example, the priority level may be based on a ratio of the expected time to the slack. The priority level may be based on slack, remaining time, etc. according to any of the SLA types specified. For example, the SLA may specify the least costly option with increased latency. In that case, the priority may be based on the execution costs on the remaining invocations on replicas 706 and select the replica 706 that incurs less cost and/or prioritizes least costly replicas. In another example, a slack for each of the task nodes for each of the available replicas 706 may be determined and the replica 706 having the largest slack among the available replicas 706 may be chosen. In some aspects, a slack for each task node of the selected replica 706 may be determined and the bounded task queue 708 may be reordered depending on the slack of each task node and the incoming workflow request 1602, such as specified in step 1036.

Through selecting the replica 706 with the minimum remaining time, incorporating metrics and/or profile data, and/or accounting for service level agreement, the scheduler 510 may be able to satisfy service level objectives (SLO) to ensure that standards of reliability and performance may be achieved. For example, a goodput rate may be achieved such as a percentage of workflow requests 204 meet the service level agreement. In other examples, a time to first token (TTFT) and/or a time per output token (TPOT) may exceed that of other types of scheduling. One or more conditions of the parallel processing cluster 700 may be difficult to reproduce precisely and performance issues of foundation models may be linked to resource consumption. Techniques described herein may schedule the workflow requests 204 onto the replicas 706 to maximize a resource utilization while stratifying SLOs. Prior approaches may not satisfy the processing of foundation models, such as, for example, round robin, shortest queue first scheduler 520 (e.g. shortest queue length), and/or power-of-two scheduler 518, where the next replica is chosen based on randomly selecting two replicas and out of which the replica with shortest queue is chosen.

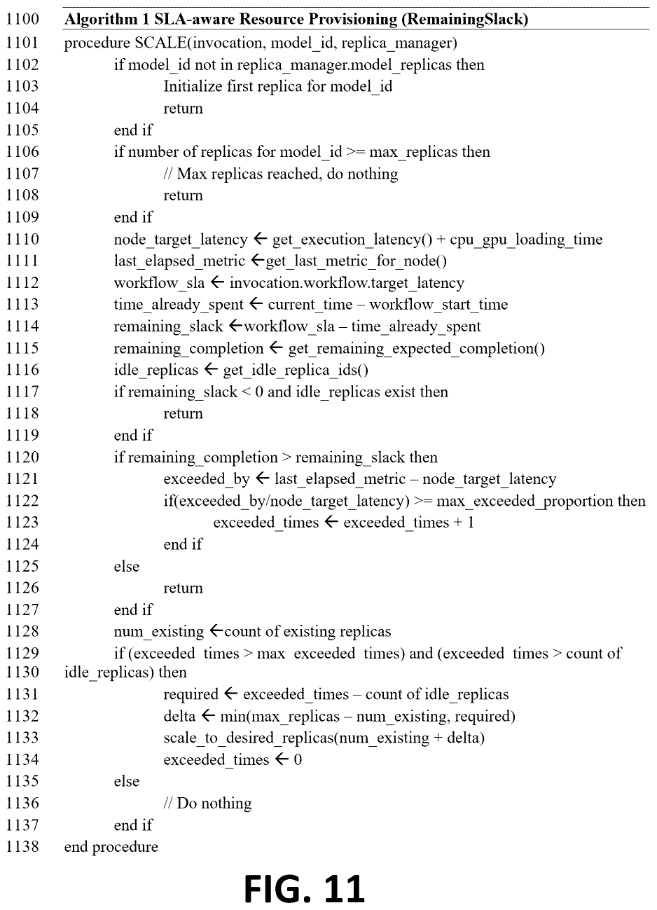

Turning to FIG. 11, a resource provisioner method 1100 provides the resource provisioner 600 when executed. Although the resource provisioner method 1100 described relates to latency, the techniques may apply equally well to other performance metrics. The resource provisioner method 1100 may begin at step 1102 by determining when the model retrieved from the unbounded request queue 308 does not match any currently executing replicas 706 and in response, initializes a first replica for the retrieved model at step 1103. When the number of replicas is greater than or equal to a maximum number of that particular model at steps 1106 to 1109, then the resource provisioner method 1100 returns without performing any additional steps.

The resource provisioner method 1100 may retrieve a target node latency at step 1110 from an execution latency and a CPU/GPU loading time. The resource provisioner method 1100 may retrieve a last elapsed metric for the task node 208 at step 1111.

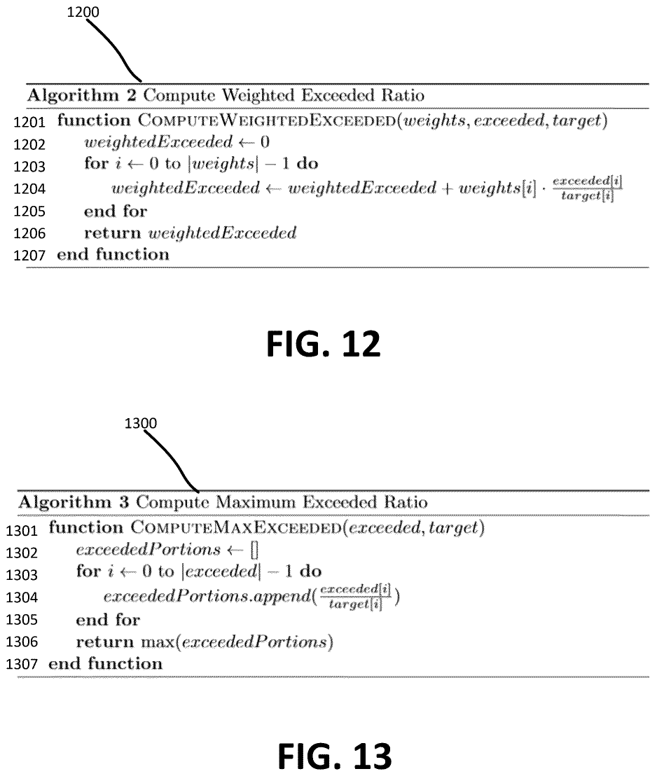

The resource provisioner method 1100 may retrieve the service level agreement for the workflow request 204 at step 1112. In this aspect, the service level agreement corresponds with a target latency for the workflow request 204. Other aspects may have the service level agreement specify a bandwidth, a cost, uptime availability, power usage, inference latency, token generation speed, time between tokens, time to first token, inference cost incurred in generating tokens, and/or any measurable quality/attribute of the system. In the case of considering multiple SLA objectives simultaneously, aggregate functions may be used as substitute to step 1121 of FIG. 11, to obtain a severity of the SLA violation(s). Examples of such aggregate functions include but may not be limited to an average scheme weighted by each metric's importance as shown on FIG. 12, or by maximum value shown on FIG. 13.

At step 1113, a processing time spent on the workflow request 204 may be determined based on the workflow start time and a current time. At step 1114, a remaining slack may be determined as a difference between the service level agreement (e.g. target latency) and the processing time spent. In this aspect, the slack may be a buffer time available within a maximum allowed latency defined by the service level agreement. At step 1115, a remaining time for completion may be retrieved for the workflow request 204.

At step 1116, a number of idle replicas may be retrieved. When the slack is less than zero (indicating an SLA violation) and idle replicas 706 exist at step 1117, the resource provisioner method 1100 returns as there are idle replicas 706 to process the task node 208.

When the remaining time for completion exceeds the remaining slack at step 1120 (indicating an SLA violation), an amount exceeded may be determined based on the last elapsed metric and the target node latency at step 1121. The amount exceeded may control a frequency of the autoscaling and/or may fine tune stability of the cluster resources. When a ratio of the amount exceeded to the target node latency is greater than or equal to a maximum exceeded proportion at step 1122, then an exceeded times counter is incremented at step 1123. Otherwise, the resource provisioner method 1100 returns at step 1126. In this manner, an SLA violation may be counted when the slack value in the task node 208 is greater than the exceeded proportion. For example, an allotted slack of 10-seconds with an exceeded proportion of 0.1, may only count SLA violations when the expected execution time is beyond 11-seconds (e.g. (10*0.1)+10). The ratio may control a sensitivity to SLA violations and/or may fine tune resource demand dynamically when SLAs change.

A number of existing replicas 706 may be determined at step 1128. At step 1129-1130, when the exceeded times counter is greater than a threshold and the exceeded times counter is greater than the number of existing replicas 706 (e.g., replicas that are loaded into memory and/or are currently executing), a scaling process 1133 may be executed. The scaling process 1133 may be based on a calculated number of replicas 706 and a delta that are determined at steps 1131 and 1132 respectively. The calculated number of replicas 706 to adequately process the task nodes may be based on the exceeded times counter subtracted by the number of idle replicas 706. The delta may be calculated as a minimum of the maximum number of replicas subtracted by the number of existing replicas and the calculated number of replicas 706.

Returning to FIG. 12, a weighted aggregate function 1200 is shown. The weighted aggregate function 1200 may receive one or more weights corresponding to each of the SLA objectives. At step 1203-1205, a weight exceeded amount may be determined by accumulating a weight for each of the SLA objectives multiplied by and exceeded amount divided by the SLA target amount. In this manner, higher priority SLA objectives may be assigned higher weights and therefore exhibit an increased influence on the severity of the SLA violations. The workflow request 204 having higher weighted SLA objectives (and therefore higher SLA violations) may be assigned more resources by the resource provisioner 600. Likewise, lower priority SLA objectives may be assigned lower weights and therefore exhibit a lesser influence on the severity of the SLA violations. The workflow request 204 having lower weighted SLA objectives (and therefore lower SLA violations) may be given less resources by the resource provisioner 600.

Returning to FIG. 13, a maximum value function 1300 is shown. The maximum value function 1300 may evaluate each of the SLA objectives for each of the workflow requests 204 and append the SLA violations in an array, such as at step 1304. The maximum value function 1300 may then return the maximum value from the array for the SLA violation at step 1306 corresponding to the workflow request with the maximum SLA violation.

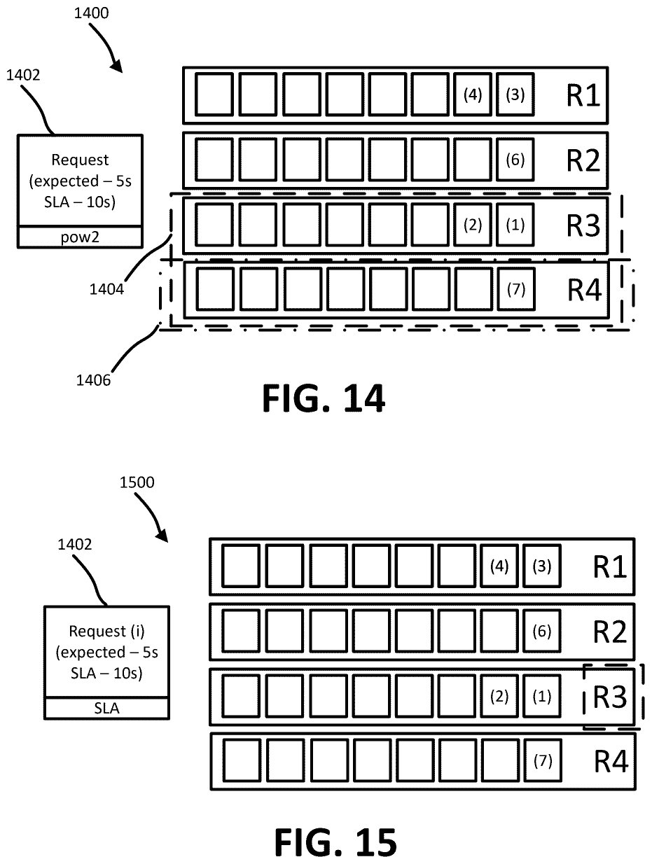

Turning to FIGS. 14 and 15, there is provided an example of a power-of-two scheduler 518 shown in FIG. 14 in comparison to the scheduling method 1000 shown in FIG. 15. In the power-of-two technique 1400, the incoming workflow request 1402 may have an SLA of 10-seconds and an expected time to complete of 5-seconds. The technique 1400 randomly selects replicas R3 and R4 from the set of replicas R1 to R4. The technique 1400 then selects the replica R4 since this replica R4 has the shortest queue length (e.g. one versus two for R3). The incoming workflow request 1402 is placed on the queue for replica R4. In this example, the replica R4 has a task node 1406 that takes 7-seconds to process and therefore, the SLA is violated since the incoming workflow request 1402 and the task node 1406 takes 12-seconds to complete exceeding the SLA of 10-seconds.

Using the similar example 1500 shown in FIG. 15, the scheduling method 1000 determines a queuing delay for each of the replicas R1 to R4, which are 7-seconds, 6-seconds, 3-seconds, and 7-seconds respectively. The scheduling method 1000 selects replica R3 as this replica has the shortest estimated queuing delay. As can be seen, the estimated queuing delay of 3-seconds plus the 5-seconds expected to process the incoming workflow request 1402 results in 8-seconds and therefore does not violate the SLA of 10-seconds.

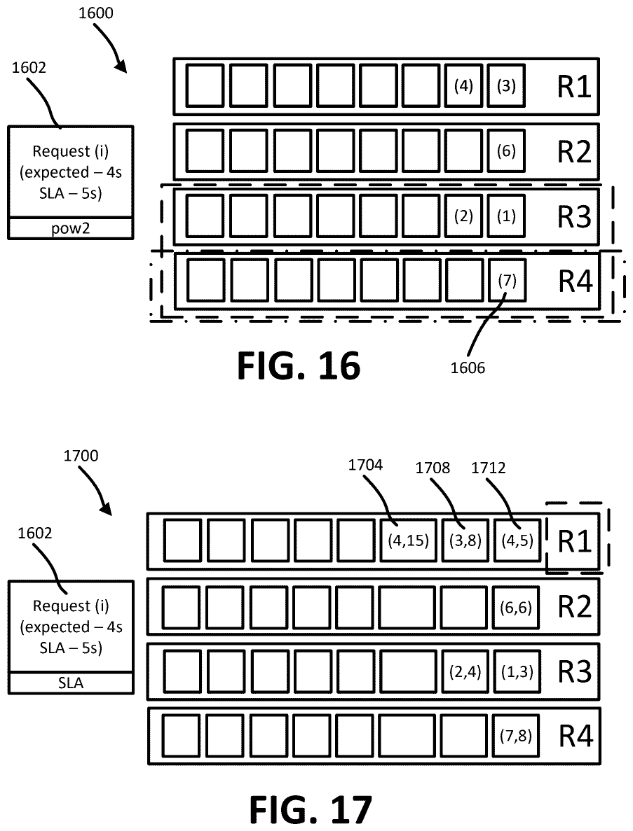

In yet another example shown in FIGS. 16 and 17, there is provided an example of a power-of-two scheduler 518 shown in FIG. 16 in comparison to the scheduling method 1000 shown in FIG. 17 and demonstrating the priority aspect. In the power-of-two technique 1600, the incoming workflow request 1602 may have an SLA of 5-seconds and an expected time to complete of 4-seconds. The technique 1600 randomly selects replicas R3 and R4 from the set of replicas R1 to R4. The technique 1600 then selects the replica R4 since this replica R4 has the shortest queue length (e.g. one task node versus two task nodes for R3). The incoming workflow request 1602 is placed on the queue of replica R4. In this example, the replica R4 has a task node 1606 that takes 7-seconds to process and therefore, the SLA is violated since the incoming workflow request 1602 and the task node 1606 takes 11-seconds to complete exceeding the SLA of 5-seconds.

Using the similar example 1700 shown in FIG. 17, the scheduling method 1000 determines a queuing delay for each of the replicas R1 to R4. In this aspect, the pairs (x, y) for each task node represent an expected time to process and the SLA respectively. For replica R1, the expected time to process the two task nodes are 4-seconds and 3-seconds respectively and the SLAs are 15-seconds and 8-seconds respectively. For replica R2 the expected time to process the task node is 6-seconds with the SLA of 6-seconds. For replica R3, the expected time to process the two task nodes are 2-seconds and 1-second respectively and the SLAs are 4-seconds and 3-seconds respectively. For replica R4, the expected time to process the one task node is 7-seconds and the SLA is 8-seconds.

The scheduling method 1000 determines the slack for each task node as 11-seconds and 5-seconds respectively for a total slack for replica R1 of 16-seconds. The scheduling method 1000 determines the slack for the replica R2 to be 0-seconds. The scheduling method 1000 determines the slack for each task node as 2-seconds and 2-seconds respectively for a total slack for replica R3 of 4-seconds. The scheduling method 1000 determines the slack for replica R4 to be 1-second. The scheduling method 1000 selects replica R1 as the replica has a maximum amount of slack available and/or the task nodes of replica R1 are all meeting their respective SLAs.

The scheduling method 1000 may then determine the slack for the incoming workflow request 1602 of 1-second. Since the incoming workflow request 902 has less slack than the task nodes 1704, 1708, the incoming workflow request 1602 is given a higher priority than these task nodes 1704, 1708. Therefore, the scheduling method 1000 places the incoming workflow request 1602 at a head 1712 of the queue. In this aspect, none of the task nodes exceed their respective SLAs.

In comparison to the power-of-two scheduler 518, the scheduling method 1000 may show up to a 60% reduction in SLA violations under heavy loads and may have a goodput rate of more than 80%, even at higher loads for multi-tenant/multi-application scenarios.

It may be understood that the units in the computing structure 100 may be logical or functional. Each function may correspond to one functional unit, or two or more functions may be integrated into a single functional unit. In actual implementation, all or some of the units may be integrated into a single physical entity or may be distributed across different physical entities. In addition, the functional units may be implemented in the form of hardware, software, or a combination of hardware and software. Whether a function is implemented in the form of hardware or software depends on applications and design constraint conditions of the technical solutions. A person skilled in the art may use different methods to implement the described functions for specific applications, but it should not be considered that the implementation goes beyond the scope of this disclosure.

In an example, a functional unit in any one of the computing structure 100 may be configured as one or more integrated circuits for implementing the methods disclosed herein, for example, as one or more application-specific integrated circuits (application-specific integrated circuits (ASICs)), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

A processor 902 or GPU 814 may be referred to as a processor system, an application processor, a baseband processor, a processor circuit, or a processor core. The processor 902 or GPU 814 may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence (AI) processors, or one or more neural network processing units (NPUs).

Memory 816, 904 may include one or more of the following storage media: a random access memory (RAM), a static random access memory (static RAM (SRAM)), a dynamic random access memory (dynamic RAM, DRAM), a phase-change memory (PCM), a resistive random access memory (resistive RAM, ReRAM), a magneto-resistive random access memory (magneto-resistive RAM (MRAM)), a ferroelectric random access memory (ferroelectric RAM (FRAM)), a cache, a register, a read-only memory (ROM), a flash memory (flash memory), an erasable programmable read-only memory (erasable programmable ROM (EPROM)), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a ReRAM, an MRAM, a FRAM, a cache, or a register), so that the processor executes the computer program instructions to perform the steps in the method embodiments disclosed herein.

Although the aspects herein describe provisioning resources for Foundation Model workloads in a cluster or datacenter setting, the techniques herein may be extended to include internet-scale distributed workflows with SLA guarantees when executing workloads on a topology of unstably networked heterogeneous machines.

In the present disclosure, the terms “a” or “an” are defined to mean “at least one”, that is, these terms include a plural number of items, unless stated otherwise.

In the present disclosure, terms such as “substantially”, “generally” and “about”, which modify a value, condition, or characteristic of a feature of an example aspect, should be understood to mean that the value, condition, or characteristic is defined within tolerances that are acceptable for the proper operation of the example aspect for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustic, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exists, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priority, or importance of the plurality of objects.

A person skilled in the art should understand that embodiments of this application may be provided as a method, an apparatus (or system), non-transitory computer-readable storage medium, or a computer program product. Therefore, this application may use a form of a hardware-only aspect, a software-only aspect, or an aspect with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. Computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or another programmable device, so that computer-implemented processing is generated. Therefore, the instructions executed on the computer or on another programmable device provide steps for implementing specific functions as described in one or more procedures in the flowcharts and/or one or more blocks in the block diagrams.

A person skilled in the art can make various modifications and variations to this application without departing from the scope of this disclosure. This disclosure is intended to cover these modifications and variations of this application if they fall within the scope of protection defined by the following claims and their equivalent technologies.

What is claimed is:

1. A system comprising:
at least one processor; and
a memory coupled to the at least one processor, the memory storing a plurality of processor-executable instructions which, when executed, configure the at least one processor to:
determine a slack from a performance target and an amount of consumed resources for a workflow request, the workflow request referencing a workflow, the workflow comprising at least one machine learning model;
determine an available resource for at least one replica executing on at least one computational node;
select a chosen replica, from the at least one replica, based on an amount of the available resource; and
route the at least one machine learning model of the workflow to a task queue associated with the chosen replica for execution.

2. The system according to claim 1, the processor-executable instructions, when executed, further configure the at least one processor to:
resolve the workflow into the at least one machine learning model and determine an execution sequence for the at least one machine learning model; and
route the at least one machine learning model in the execution sequence into a request queue.

3. The system according to claim 2, the processor-executable instructions, when executed, further configure the at least one processor to:
retrieve, from the request queue, a retrieved model from the at least one machine learning model; and
identify the workflow request corresponding to the retrieved model to determine the slack from the performance target and the amount of the consumed resources.

4. The system according to claim 3, the processor-executable instructions, when executed, further configure the at least one processor to:
select the retrieved model based on the slack corresponding to the amount of the available resource of the chosen replica.

5. The system according to claim 1, the processor-executable instructions, when executed, further configure the at least one processor to:
determine a remaining resource to complete the workflow request; and
track a slack violation amount responsive to the remaining resource exceeds the slack.

6. The system according to claim 5, the processor-executable instructions, when executed, further configure the at least one processor to:
deploy at least one new replica to the at least one computational node; and
route at least one remaining task node of the workflow referenced by the workflow request to the task queue associated with the at least one new replica.

7. The system according to claim 6, wherein an amount of the at least one new replica is based on the slack violation amount.

8. The system according to claim 1, the processor-executable instructions, when executed, further configure the at least one processor to:
profile the workflow to determine a profiled slack with an offline profiler;
compare the slack to the profiled slack; and
responsive to the slack exceeding the profiled slack, deploy at least one new replica to the at least one computational node.

9. The system according to claim 1, the processor-executable instructions, when executed, further configure the at least one processor to:
aggregate a plurality of metrics to determine the amount of the consumed resources when determining the slack.

10. The system according to claim 9, the processor-executable instructions, when executed, further configure the at least one processor to:
weight at least one of the metrics as part of the aggregation.

11. A computer-implemented method comprising:
determining a slack from a performance target and an amount of consumed resources for a workflow request, the workflow request referencing a workflow, the workflow comprising at least one machine learning model;
determining an available resource for at least one replica executing on at least one computational node;
selecting a chosen replica, from the at least one replica, based on an amount of the available resource; and
routing the at least one machine learning model to a task queue associated with the chosen replica for execution.

12. The computer-implemented method according to claim 11, further comprising:
resolving the workflow into the at least one machine learning model and determine an execution sequence for the at least one machine learning model; and
routing the at least one machine learning model in the execution sequence into a request queue.

13. The computer-implemented method according to claim 12, further comprising:
retrieving, from the request queue, a retrieved model from the at least one machine learning model; and
identifying the workflow request corresponding to the retrieved model to determine the slack from the performance target and the amount of the consumed resources.

14. The computer-implemented method according to claim 13, further comprising:
selecting the retrieved model based on the slack corresponding to the amount of the available resource of the chosen replica.

15. The computer-implemented method according to claim 11, further comprising:
determining a remaining resource to complete the workflow request; and
tracking a slack violation amount responsive to the remaining resource exceeds the slack.

16. The computer-implemented method according to claim 15, further comprising:
deploying at least one new replica to the at least one computational node; and
routing at least one remaining task node of the workflow referenced by the workflow request to the task queue associated with the at least one new replica.

17. The computer-implemented method according to claim 16, wherein an amount of the at least one new replica is based on the slack violation amount.

18. The computer-implemented method according to claim 11, further comprising:
profiling the workflow to determine a profiled slack with an offline profiler;
comparing the slack to the profiled slack; and
responsive to the slack exceeding the profiled slack, deploying at least one new replica to the at least one computational node.

19. The computer-implemented method according to claim 11, further comprising:
aggregating a plurality of metrics to determine the amount of the consumed resources for determining the slack; and
weighting at least one of the metrics as part of the aggregating.

20. A non-transitory computer-readable storage medium comprising processor-executable instructions which, when executed, configure at least one processor to:
determine a slack from a performance target and an amount of consumed resources for a workflow request, the workflow request referencing a workflow, the workflow comprising at least one machine learning model;
determine an available resource for at least one replica executing on at least one computational node;
select a chosen replica, from the at least one replica, based on an amount of the available resource; and
route the at least one machine learning model to a task queue associated with the chosen replica for execution.
